(19) United States
(12) Patent Application Publication
(10) Pub. No.: US 2016/0215828 A1
(43) Pub. Date: Jul. 28, 2016

(54) RAMP SYSTEM FOR ACTUATING A FRICTIONAL CLUTCH

(71) Applicant: SCHAEFFLER TECHNOLOGIES AG & CO. KG, Herzogenaurach (DE)

(72) Inventors: Marc Finkenzeller, Gengenbach (DE); Daniel Helmer, Ottenhofen (DE)

(73) Assignee: Schaeffler Technologies AG & Co. KG, Herzogenaurach (DE)

(21) Appl. No.: 15/021,092

(22) PCT Filed: Oct. 20, 2014
(86) PCT No.: PCT/DE2014/200567

§ 371 Date: Mar. 10, 2016

(30) Foreign Application Priority Data
Nov. 13, 2013 (DE) 102013223044.3
Mar. 28, 2014 (DE) 102014205850.3

(51) Int. Cl. F16D 13/04; F16H 25/18; F16D 13/54

(52) U.S. Cl. CPC F16D 13/04; F16D 13/54; F16H 25/186

(57) ABSTRACT

A ramp system for actuating a frictional clutch, in particular a wet or dry multiple disc clutch, for coupling a drive shaft of a motor vehicle engine to at least one transmission input shaft, having an entrance ramp for introducing an actuating torque, an exit ramp, which is rotatable relative to the entrance ramp, for opening and/or closing the frictional clutch and a reset spring, configured as a leaf spring and connected to the entrance ramp and the exit ramp, for rotating the exit ramp relative to the entrance ramp to a defined starting position. At least one part of the torque transferred to the exit ramp can be transferred via the reset spring, the reset spring extends between a torque initiation point of the entrance ramp and a torque exit point of the exit ramp, substantially in the tangential direction, and extends at a setting angle to a radial plane of the ramp system. The reset spring allows an increase of the actuating force on the exit ramp in the case of an increase of the axial extension of the ramp system. By also using the reset spring, which extends tangentially at an angle to the radial plane, for torque transfer, a pressing force which decreases as the friction linings wear can at least be compensated by a modification of the direction of force of the torque introduced via the reset spring such that a secure closing of a frictional clutch is enabled, requiring only a small amount of design effort, wherein a particularly comfortable coupling of an internal combustion engine to a drive train of a hybrid motor vehicle is in particular simultaneously enabled.

### BACKGROUND

The invention relates to a ramp system for actuating a friction clutch, particularly a wet or dry multiple disk clutch, which allows to open and/or close the friction clutch by changing the axial extension of the ramp system in order to couple the drive shaft of a motor vehicle engine to at least one transmission input shaft of a motor vehicle transmission.

A wet multiple disk clutch is known from DE 10 2010 048 827 A1 for coupling a drive shaft of a motor vehicle engine to a transmission input shaft of a motor vehicle transmission, in which a pilot clutch is provided with a ramp mechanism in order to achieve increased compression in the closed state of the friction clutch.

There is a permanent need to allow securely closing a friction clutch with low construction expense.

### SUMMARY

The objective of the invention is to provide measures allowing a secure closure of a friction clutch with low construction expense.

The objective is attained with a ramp system according to the invention. Preferred embodiments of the invention are disclosed below and in the claims, and here each of which may represent an aspect of the invention individually or in combinations.

According to the invention a ramp system is provided for actuating a friction clutch, particularly a wet or dry multiple disk clutch, for coupling a drive shaft of a motor vehicle engine to at least one transmission input shaft, comprising an entrance ramp for introducing an actuating moment, an exit ramp that can be distorted in reference to the entrance ramp for opening and/or closing the friction clutch, and a reset spring, embodied as a leaf spring and connected to the entrance ramp and the exit ramp for rotating the exit ramp in reference to the entrance ramp into a defined starting position, in which at least a portion of the torque transmitted to the exit ramp can be transmitted via the reset spring, with the reset spring essentially extending in a tangential direction between a torque input point of the entrance ramp and a torque output point of the exit ramp and extending diagonally at a setting angle in reference to the radial plane of the ramp system, with here the reset spring allowing an increase of the actuating force at the exit ramp in case of an increase of the axial extension of the ramp system.

The reset spring embodied as a leaf spring is not only used for approaching a defined relative position of the entrance ramp towards the exit ramp into the starting position but also for transmitting at least a portion of the actuating moment introduced into the friction clutch. Here, the knowledge is utilized that over the wear section of friction linings of the friction clutch the axial displacement path of a compression area of the exit ramp, pointing away from the entrance ramp, increases in reference to the exit ramp and therefore the setting angle of the reset spring changes in reference to the radial plane. The axial stroke of the compression area is equivalent to the change of the axial extension of the ramp system. By the increasing or reducing setting angle here the force ratios at the reset spring change like a diagonally operated knee lever such that the portion of force extending in the longitudinal direction of the reset spring changes. Accordingly, the portion of force pointing in the axial direction of the ramp system changes at the end of the reset spring at the output side in the direction of flow of force such that depending on the stroke of the compression area, which corresponds to the wear condition of the friction lining, an appropriately higher axial force can be applied by the reset spring in order to at least partially compensate in the closed state of the friction clutch the increasing reset force of the reset spring caused by wear. This way, the compression force of the ramp system and/or the required actuating force for actuating the friction clutch can remain within a comparatively narrow range over the wear area of the friction linings, and particularly remain essentially constant.

The ramp system can therefore be used particularly for a friction clutch, with the help of which an internal combustion engine can be coupled to the drive train of a hybrid vehicle. Such a friction clutch, also called E-clutch, may represent a rotor-integrated clutch, which connects the internal combustion engine to an electric machine as well as the drive train. The E-clutch may here rotate with the rotor of the electric machine and/or couple the internal combustion engine to the rotor of the electric machine. The electric machine can be used to start the internal combustion engine. If electric driving is already given at the time the internal combustion engine is started, the electric machine can increase the moment provided at said time in order to increase the starting moment of the internal combustion engine, and simultaneously allow closing the E-clutch. This way a torque can flow from the electric machine to the internal combustion engine in order to start the internal combustion engine. Here, particularly the moment of the E-clutch that can be transmitted can be adjusted very precisely to the starting moment so that no longitudinal acceleration of the motor vehicle occurs. By compensating the increasing reset force of the reset spring in worn friction linings by the changing transmission of force of the reset spring, the torque to be transmitted by the E-clutch can essentially be independent from the wear of the friction linings so that a very comfortable and essentially unnoticed coupling of the internal combustion engine to the drive train can occur or a decoupling therefrom. By the use of the reset spring extending diagonally in reference to the radial plane for the transmission of torque as well, here any compression reducing by the wear of the friction lining can be compensated by a change of the direction of force of the torque introduced via the reset spring at least such that a secure closing of a friction clutch is possible with low constructive expense, particularly allowing simultaneously a very comfortable coupling of the internal combustion engine to a drive train of a hybrid vehicle.

Depending on the constructive design of the ramp system the reset spring can be stressed for pressure or tension. When the reset spring is stressed for pressure in order to transmit torque, the reset spring embodied as a leaf spring may be stressed up to a force for bending, which is below the buckling force and extends in the longitudinal direction of the leaf spring. In particular, several reset springs are provided which are evenly distributed particularly in the circumferential direction, here on a common nominal radius such that the forces applied at the individual reset springs can be reduced. In particular, the reset spring extends essentially in a tangential fashion and can bridge an axial path by its setting angle in reference to the radial plane. It is also possible that a portion of the reset spring extends in the radial direction, with particularly the portion of the longitudinal extension of the reset spring being considerably greater in the tangential direction than in the radial direction. The reset spring exhibits particularly several layers of springs, arranged over top of each other, each of which particularly produced from steel sheets. Several layers of springs may be riveted together, for example. In particular the reset spring is stiffened and embodied accordingly in a kink-proof fashion, for example by beads embossed in the layers of springs. In order to actuate the ramp system the entrance ramp, preferably fixed in the axial direction, can be rotated in reference to the exit ramp, which is torque-proof particularly in the circumferential direction. For this purpose, with the help of the pilot control element, a respective torque can be introduced into the ramp system. For example, with the help of an eddy-current brake, torque can be introduced, generated by an electric machine of a hybrid vehicle. The torque introduced may act directly upon the entrance ramp, or indirectly transmitted to the entrance ramp, particularly after a torque conversion, for example with the help of a planetary gear. The ramp system may be embodied as an actuating element for closing and/or opening a friction clutch, with particularly the compression area of the exit ramp pointing away from the entrance ramp being able to engage a friction lining of a friction clutch. This way, the exit ramp can already form a compression plate and/or steel disk of the friction clutch. The friction clutch, particularly embodied as a wet or dry multiple disk clutch, exhibits several frictional pairings provided behind each other between the input part and the output part. Preferably, with the help of a coolant, particularly oil, friction heat can be dissipated from the friction clutch such that the friction clutch can be embodied particularly as a wet multiple disk clutch. The input part and/or the output part may show a disk carrier, at which the multiple disks are guided in a fashion displaceable in the axial direction. The respective disk may be provided with friction linings or embodied as a steel disk. The friction clutch may be open in the starting state (normally open) or closed (normally closed) when no actuating force is introduced via the actuating element.

In particular, when torque is transmitted the reset spring provides an altered force transmission in the axial direction by the tangential extension of the reset spring in case of an increase of the axial extension of the ramp system, with in case of an increase of the axial extension of the ramp system the force transmission essentially compensating a change of the reset force altering in the axial direction into the starting position. This way, at least a section results between a respective relative position of the entrance ramp in reference to the exit ramp equivalent to a completely open position of the friction clutch and a relative position of the entrance ramp in reference to the exit ramp equivalent to a completely closed position of the friction clutch with worn friction linings, in which the compression force applied by the exit ramp via the compression area can be essentially constant. Additionally or alternatively, in this area the progression of the required actuating force for changing the axial extension of the ramp system may be essentially constant and/or essentially independent from the state of wear of the friction linings of the friction clutch. This allows a particularly precise control of the friction clutch via the ramp system over essentially the entire service life of the friction clutch. In particular a new adjustment of the ramp system can be waived after an exchange of the friction linings.

Preferably, an extension of the reset spring in the circumferential direction and/or the setting angle of the reset spring and/or the spring stiffness of the reset spring and/or an axial distance between the torque initiation point and the torque output point and/or a friction value of a compression area of the exit ramp pointing away from the entrance ramp is selected to compensate an increasing reset force of the reset spring in case of an increasing extension of the ramp system. Via these parameters a suitable progression of the force transmission of the reset spring as well as the reset force of the reset spring can be adjusted.

It is particularly preferred that the entrance ramp is spaced apart from the exit ramp via at least one bearing element, particularly a ball. The ramp system can this way be embodied as a ball ramp system with a low internal friction. By the bearing element particularly the exit ramp can be spaced apart from the entrance ramp to such an extent that the reset spring can easily be positioned in the axial direction between the entrance ramp and the exit ramp. This way, the reset spring can easily be connected to the entrance ramp and the exit ramp without significantly increasing the structural space required. Further it is not necessary to receive the reset spring in special recesses provided in the entrance ramp and/or the outlet ramp in a counter-sunk fashion.

In particular, the entrance ramp has a bearing part for supporting the ramp system at a bearing, with the reset spring being connected to the bearing part to form the torque initiation point. A direct connection to an area of the entrance ramp, also forming the ramp of the entrance ramp, therefore is not required, here. This way an appropriately larger portion of the entrance ramp can be used for supporting the exit ramp. Due to the fact that the reset spring can provide the torque initiation point in a respectively larger radial range additional freedoms of design are given.

Preferably the bearing part represents a planet carrier of a planetary gear for transmitting an actuating moment to the entrance ramp. By the planetary gear a torque conversion can occur such that for example a lower torque can be converted into a greater torque engaging at the entrance ramp. Due to the fact that the ramp of the entrance ramp is connected to the planetary carrier of the planetary gear in a torque-proof fashion the reset spring can also be easily connected to the planetary carrier.

The invention further relates to a friction clutch, particularly a wet or dry multiple disk clutch for coupling a drive shaft of a motor vehicle engine to at least one transmission input shaft, to an input part that can be coupled to the drive shaft particularly an input disk carrier for introducing a torque, an output part that can be coupled to the transmission input shaft particularly an output disk carrier, for the output of a torque, with it being possible to compress the input part to the output part via at least one worn friction lining, and a ramp system which may be embodied as described above and further developed for a friction-fitting compression of the output part to the input part by changing the axial extension of the ramp system. By the use of the reset spring, extending tangentially and diagonal in reference to the radial plane, also for the transmission of torque in the ramp system, here a reducing compression due to wear of the friction linings can be at least compensated by a change of the direction of force of the torque introduced via the reset spring such that a secure closing of a friction clutch is possible with low constructive expense, with simultaneously a particularly comfortable coupling of an internal combustion engine to the drive train of a hybrid motor vehicle is possible, in particular.

Especially, the reset force of the reset spring is essentially constant between the closed position of the friction clutch in case of unworn friction linings and the closed position of the friction clutch in case of worn friction linings. This way at least a section develops between a relative position of the entrance ramp to the exit ramp equivalent to a closed position of the friction clutch in case of unworn friction linings and a relative position of the entrance ramp to the exit ramp equivalent to a closed position in case of worn friction linings appropriate, in which the compression applied by the exit ramp via the compression area can essentially be constant. Additionally or alternatively in this area the progression of the necessary actuating force for changing the axial extension of the ramp system can be essentially constant and/or essentially independent from the condition of wear of the friction linings of the friction clutch. This allows a particularly precise control of the friction clutch via the ramp system over essentially the entire service life of the friction clutch. In particular, a readjustment of the ramp system can be waived after an exchange of friction linings.

Preferably, when the friction lining is not worn and in the closed position of the friction clutch, the reset spring provides a nominal return force and the reset spring, when transferring torque through the tangential progression of the reset spring, a force transmission provides in the axial direction, changing due to wear-related increase of the axial extension of the ramp system by the wear of the friction lining, with the force transmission essentially compensating a change of the nominal return force changing in a wear-related increase of the axial extension of the ramp system. This way, the nominal return force can be essentially independent from the condition of wear of the friction linings. In particular, the actuating force introduced into the ramp system and the friction clutch may be designed for a nominal return force, without requiring here significant additional safety buffers, which are not necessary. Any unnecessary oversizing of the actuating force can be avoided thereby.

### BRIEF DESCRIPTION OF THE DRAWINGS

In the following, the invention is explained with reference to the attached drawings based on preferred exemplary embodiments, with the features shown in the following each representing aspects of the invention, both individually as well as in combinations. Shown are:

FIG. 1: a schematic cross-section of a clutch assembly, and

FIG. 2: a schematic side view of a ramp system for the clutch assembly of FIG. 1.

### DETAILED DESCRIPTION OF THE PREFERRED EMBODIMENTS

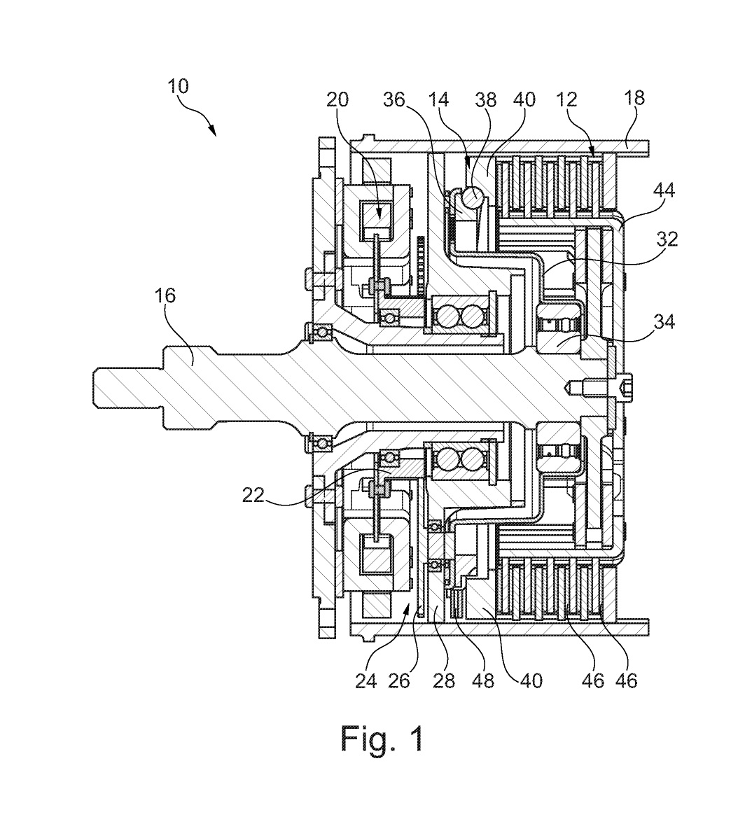

The clutch assembly 10 shown in FIG. 1 comprises a friction clutch 12, embodied as a dry multiple disk clutch, which can be opened and/or closed with the help of a ramp system 14 in order to generate and/or disconnect a torque flow between a drive shaft 16 of a motor vehicle engine embodied as an internal combustion engine and a transmission input shaft of a motor vehicle transmission that can be connected via an output part 18 of the friction clutch 12. The output part 18 can simultaneously represent a part of a rotor of an electric machine for driving a motor vehicle. This allows particularly with the help of an eddy-current brake 20 to tap a portion of the torque provided by the electric machine via the output part 18. The eddy-current brake 20 is connected in a torque-proof fashion to a sun gear 20 of a planetary gear 24. The planetary gear 24 has several, particularly three planetary wheels 26 combing the sun gear 22, which are supported at a planetary carrier 28. This way, the torque obtained via the eddy-current brake 20 can be suitably converted.

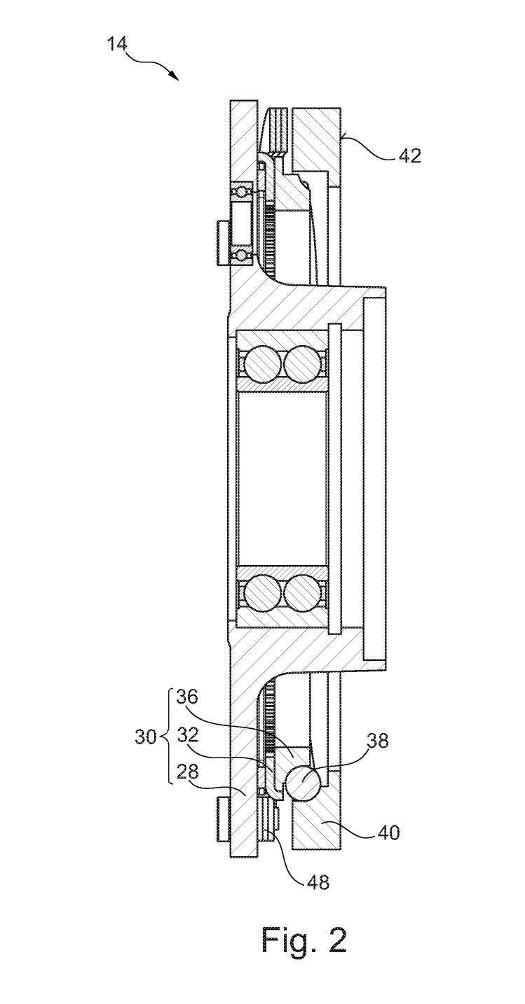

As shown in FIG. 2, the planetary carrier 28 may be a part of a multi-part entrance ramp 30 of the ramp system 14. The entrance ramp 30 shows further a bearing part 32, by which the entrance ramp 30 and the ramp system 14 are supported at a bearing 34 resting on the drive shaft 16. In order to form an entrance ramp 30 the planetary carrier 28 is connected in a torque-proof fashion via the bearing part 32 to a ramp element 36. The total entrance ramp 30 is rotational in the circumferential direction and supported immobile in the axial direction. An exit ramp 40 is supported on the ramp element 36 of the entrance ramp 30 via the bearing element 38 embodied as balls, which is particularly coupled in a torque-proof fashion to the output part 18 and is mobile in the axial direction. In a rotation of the entrance ramp 30 in reference to the exit ramp 40 the extension of the ramp system 14 changes in the axial direction so that a compression area 42 of the exit ramp 40, pointing away from the entrance ramp 30, can be axially displaced in order to allow opening and/or closing the friction clutch 12.

In the closed state of the friction clutch 12, an input part 44 of the friction clutch can be compressed via friction linings 46, subject to wear, to the output part 18 in a friction-fitting fashion. The input part 44 is connected to the drive shaft 16 in a torque-proof fashion such that in the closed state of the friction clutch 12 the motor vehicle engine is coupled to the output part 18 in order to introduce a starting moment to start the engine of a motor vehicle via the drive shaft 16 into the engine of a motor vehicle or to transfer a torque generated by the motor vehicle engine via the drive shaft 16 to the output part 18. The output part 18 can be coupled, particularly via a separating clutch, to at least a transmission input shaft of a motor vehicle transmission.

If no torque is introduced via the eddy-current brake 20 into the ramp system 14, the compression force cannot be introduced any longer from the compression area 42 of the outlet ramp 40 into the friction clutch 12. With the help of a reset spring 48, embodied as a leaf spring, the ramp system 14 can be returned into a relative position which is equivalent to an open position of the friction clutch 12. In the exemplary embodiment shown the reset spring 48 is fastened radially outside the ramp element 36 of the entrance ramp 30 at sides of the planetary carrier 36 and the outlet ramp 40 facing each other. The reset spring 48 can therefore extend between a torque initiation point of the entrance ramp 30 embodied by the connection site with the planetary carrier 36 and a torque output point of the exit ramp 40 embodied by the connection point to the exit ramp 40 essentially in the tangential direction and this way transmit a portion of the torque introduced via the planetary carrier 36. The reset spring 48 extends diagonally about a setting angle in reference to a radial plane of the ramp system 14, with here the achieved setting angle in the closed position of the friction clutch 12 changing depending on the wear condition of the friction linings 46 and an increased displacement path of the compression area 42 connected thereto. This way, the force transmission of the reset spring 48 changes such that a return force of the reset spring 48, increased by wear, can be compensated in the closed position of the friction clutch 12.

### LIST OF REFERENCE CHARACTERS

10 Clutch assembly
12 Friction clutch
14 Ramp system
16 Drive shaft
18 Output part
20 Eddy-current brake
22 Sun gear
24 Planetary gear
26 Planet wheel
28 Planet carrier
30 Entrance ramp
32 Bearing part
34 Bearing
36 Ramp element
38 Bearing elements
40 Exit ramp
42 Compression area
44 Input part
46 Friction lining
48 Reset spring

1. A ramp system for operating a friction clutch, comprising an entrance ramp for introducing an actuating moment, an exit ramp that is rotational in reference to the entrance ramp for at least one of opening or closing the friction clutch, and a reset spring connected to the entrance ramp and the exit ramp and embodied as a leaf spring for rotating the exit ramp in reference to the entrance ramp in a defined starting position, with at least a portion of a torque transmitted to the exit ramp being transmittable via the reset spring, the reset spring extending between a torque initiation point of the entrance ramp and a torque output point of the exit ramp essentially in a tangential direction and diagonal about an angle in reference to a radial plane of the ramp system, with the return spring allowing an increase in actuating force at the exit ramp when an axial extension of the ramp system increases.

2. The ramp system according to claim 1, wherein during a transmission of torque the reset spring provides by a tangential extension of the reset spring a transmission of force in an axial direction, changing during an increase of the axial extension of the ramp system, with the transmission of force essentially compensating a change of a return force of the reset spring into a starting position changing during an increase of the axial extension of the ramp system in the axial direction.

3. The ramp system according to claim 1, wherein at least one of the extension of the reset spring is selected in a circumferential direction, a setting angle of the reset spring, a spring stiffness of the reset spring, an axial distance between the torque initiation point and the torque output point, or a friction value of a compression area of the exit ramp pointing away from the entrance ramp are selected for compensating an increasing return force of the reset spring in an increasing extension of the ramp system.

4. The ramp system according to claim 1, wherein the entrance ramp is spaced apart from the exit ramp via at least one bearing element.

5. The ramp system according to claim 1, wherein the entrance ramp comprises a bearing part for supporting the ramp system at a bearing, and the reset spring is connected to the bearing part to form the torque initiation point.

6. The ramp system according to claim 5, wherein the bearing part is a planet carrier of a planetary gear to transfer an actuating moment at the entrance ramp.

7. A friction clutch, comprising an input part that can be is couplable to the drive shaft for introducing a torque, an output part that is couplable to the transmission input shaft, the input part being compressed via at least one friction lining subject to wear to the output part, and a ramp system according to claim 1, for the friction-fitting compression of the output part to the input part by a change of the axial extension of the ramp system.

8. The friction clutch according to claim 7, wherein the return force of the reset spring is essentially constant between the closed position of the friction clutch in a friction lining that is not worn and the closed position of the friction clutch when the friction lining is worn.

9. The friction clutch according to claim 7, wherein the reset spring provides a nominal return force in the closed position of the friction clutch when the friction lining is not worn, and the reset spring during the transmission of the torque via the tangential extension of the reset spring, changes by a wear-related increase of the axial extension of the ramp system by wear of the friction linings, with the force transmission essentially compensating a change of the nominal return force in case of the wear-related increase of the axial extension of the ramp system.
